(19) United States
(12) Patent Application Publication
(10) Pub. No.: US 2010/0140193 A1
(43) Pub. Date: Jun. 10, 2010

(54) HYDROTRANSISTORS AND INTEGRATED HYDROLOGIC CIRCUITS

(76) Inventor: Kenneth J. Hsu, Surrey (GB)

Correspondence Address: BREINER & BREINER, L.L.C., P.O. BOX 320160, ALEXANDRIA, VA, 22320-0160, US

(21) Appl. No.: 12/312,862

(22) PCT Filed: Dec. 1, 2006
(86) PCT No.: PCT/EP2006/069183

§ 371 Date: Feb. 3, 2010

(51) Int. Cl. B01D 24/24; B01D 24/02

(52) U.S. Cl. 210/807; 210/290

(57) ABSTRACT

Integrated hydrologic circuits, with circuit element hydropotentials, hydroconductors, hydroinsulators, hydrocapacitors, and most significantly hydrotransistors for collecting, filtering, storing, and transporting water on the basis of the principle that water can flow faster through a porous medium with an enlarged cross-sectional area, under an elevated hydrodynamic potential, and of the consideration of the law of hydrodynamic continuity in constructing IHC systems of continuous flow. The devices are constructed to permit efficient exchanges between surface water and groundwaters for the purposes of urban water-supply, treatment of polluted water and waste water, irrigation, flood control and other purposes.

This is the latest of a series of inventions to construct integrated hydrologic circuits for groundwater recharge of rain and flood harvests, for filtering of polluted or waste-water, for water-saving irrigation, and for groundwater hydroelectricity. The present invention teaches the invention of the various types of hydrotransistors, and their integration into the various integrated hydrologic circuits

1) to recycle polluted and waste waters, after filtering through F-hydrotransistors, to be reclaimed as urban water supply and groundwater recharge, eliminating thereby polluted environments, achieving at the same time a balance of groundwater-exploitation so as to prevent water urban shortages and land subsidence.

2) to circulate groundwater into I-hydrotransistors for “capillary irrigation,” and to harvesting rain and flood into R-hydrotransistors for groundwater recharge, achieving at the same time a balance of groundwater-exploitation, while wasteland is reclaimed as pastures and crop fields.

3) to collect water in high valleys, from shallow underground or from sediment-laden rivers, to be filtered through F-hydrotransistors and to flow down tunnels to generate hydroelectricity, achieving thus the perpetual use of hydroelectric energy without having to build the environmentally devastating dams.

### BACKGROUND OF INVENTION

The current water shortages are a consequence of the misconception of what constitute water resources. In all textbooks, in all practices, water resources are the sum of water volumes in lakes, rivers, and other surface water-bodies. In fact the ultimate water resources are the precipitation. We need a fundamental re-thinking about the water-policy. A sustainable development of water resources depends ultimately upon a balanced exploitation of groundwater. To achieve this purpose, the groundwater reservoir is to be considered a renewable storage, the balanced budget can be achieved through non-wasteful uses, recycling, and compensation by rain- and flood-recharge.

Much of the water is wasted in evaporation and pollution. To minimize evaporation loss, a radically new technology has to be invented to replace the watering technique which has not been much changed since the New Stone Age.

To reclaim water lost to pollution for recycling, filters have been developed to remove the pollutants, but improved filters are necessary.

To compensate the exploitation of the groundwater reservoir, numerous technologies of recharge have been developed, but none so far are sufficiently economically feasible for general application.

We should recognize that recharge requires techniques of rapid inflow. Recycling requires filtering with rapid inflow and outflow. Use of groundwater for hydroelectricity requires rapid outflow to move turbines, and rapid inflow to recharge the reservoir. Water flow has been compared to flow of electrons or electricity. The acceleration of flow rate in electricity is effected by amplifiers. The most sought-after water technology is thus to find an amplifier to move water in and out of the porous medium rapidly.

### DESCRIPTION OF PRIOR DEVELOPMENT

Applying our knowledge derived from the studies of the flow of electrons in integrated electronic circuit (IC), we have invented the IHC technology, and the inventions are patented (see list of references). The IHC systems are constructed to consist of hydrologic circuit-elements, fabricated and associated within a continuous body to perform hydrologic functions. The IHC circuit elements invented so far included hydro-conductors, hydro-insulators, hydro-capacitors, hydro-filters, and hydrotransistors (previously called as aquitransistors).

The hydrotransistors are the much sought-after amplifier to accelerate the water movement in and out of porous medium. The flow rate, according to the Darcy's Law is,

Q=K(Δφ/ΔL)A (1)

where the parameter K is transmissibility, (ΔΦ/ΔL) the hydrodynamic potential gradient, and A the cross sectional area of flow. An acceleration of the flow through the porous medium can be effected through an increase of any of the three variables.

We have developed a three-layered unit which serves mainly as a filter to remove suspensions or particulate pollutants. The filter has a large area, and the potential gradient is increased through the installation of negative potential at the base to accelerate the flow rate. Those are called F-hydrotransistors. We have since conducted numerous experiments with those; we could make improvements and devise different models for different purposes. We have further developed other hydrotransistors for groundwater recharge and irrigation, for generate groundwater hydro-electricity. The present patent teaches the improved designs of the various IHC inventions.

### SUMMARY OF INVENTIONS

To solve problems in water affairs and environment protection, we have invented:

F-Hydrotransistors for filtering polluted and waste-water

R-Hydrotransistors for groundwater-recharge.

FR-Hydrotransistors for filtering before recharging.

RI-Hydrotransistors for recharging- and water-saving irrigation.

IF-Hydrotransistors for water-saving irrigation, and filtering.

FE-Hydrotransistors for filtering to generate groundwater hydro-electricity

F-Hydrotransistors

F-hydrotransistors consists of three components: i) A filtering layer of sediment grains (35), ii) perforated pipes (42) embedded a layer of sand or gravel (34), and iii) a protective mantle (36); with a grading of the sedimentary material from fine to coarse sand.

Water is pumped into a filtering pool (40), passing through the filter, the protective mantle, and is pumped out of the perforated pipes. The flow rate through the filter and that through the protective mantle are a function of the potential gradient across the filter and of the transmissibility of the filtering grains. The perforated pipes (42) near the bottom of an IHC are hydroconductors. The flow rate through the pipes is given by Bernoulli's Theorem: the rate is proportional to the pipe-diameter and the pressure gradient from one end to another end of a pipe. When water is pumped out of the pipes a negative potential is established in the system.

The potential difference between that at the top of the filtering layer and that inside the perforated pipes is the driving force of filtering.

The economy of filtering demands faster rate. The common wisdom is to increase transmissibility, which depends on the pore size, and thus indirectly on the grain size, of the filtering material. Most common filters use coarse sand, 1-2 mm in diameter as filtering material to achieve a reasonably rapid rate. Those filters cannot reclaim polluted or waste water, as bacteria and other very small particulate suspension would go through the large filter-pores.

If water-quality is an important consideration, it is undesirable to accelerate flow through an increase of transmissibility. Where water has to be made suitable for urban consumption, the pore size of the filter has to be reduced down to 1 or 2 micrometers at least.

We have designed three types of F-hydrotransistors: Type A use a well-sorted very fine-grained sand as the filter. Type B uses a medium silt or a diatomaceous earth as the filter. Type C uses a sand or silt filter mixed with chemicals chosen to precipitate toxic ions in the polluted water. We discovered that the flow rate of the three types is not a linear function of transmissibility. Type A is faster than Type B, but not so much faster as estimated on the basis of their difference in transmissibility. The law of hydrologic continuity demands an internal adjustment of the potentials in the hydro-dynamic field so that flow rate through Type A filters is only 2 or 3 times larger.

Our invention of F-hydrotransistors permits an option of many choices of speed vs. quality. In Type A units, water flows readily under gravity through the fine or medium sand filter into the semi-conducting medium of coarse sand or gravel, from where water enters the perforated pipe. In Type A filters, the flow rate is simply a function of the power of the pump to create a pressure difference across the length of the pipe to determine the pressure gradient. For a same unit, an increase of the pump power could greatly increase the flow rate. The flow rate of water coming out of Type A at Jade Lake Experimental Station, for example, is 38 liters/minute when the pipe is connected to a 450 W pump, but is increased to 60 liters/minute. The financial implication of the increase is mind-boggling: our original estimate of processing 6 million tons of waste water for Dongguang City was 7.5 billion RMB. An increase of the filtering rate represents the need of fewer units of hydrotransistors, and thus a cost-reduction to 5 billion RMB. We are still experimenting with the dimensions and the pump power of the Type A filtering units; and a slight 20% improvement would permit the cost-reduction another billion for the Dongguang Project! The filtering rate through Type A is more than 10 times faster through the so-called rapid penetration filtering system adopted by the Shenzhen government for waste-water treatment. The substitute of gravity-drive by pressure-drive is a key success of the invention.

We construct Type B filters to reclaim to obtain water of very high quality. At the Jade Lake Park, we used the medium silt as filtering material for the Type B filter, the filtering rate is about 20 liters/minute, but the product has the standard chemistry of a “pure clean water.” Those cheaply produced germ-free water can be bottled and marketed.

That the filtering rate is not a liner function of the filtering grain-size is explained by the fact that F-hydrotransistors are not isotropic and homogeneous systems. The hydrodynamic field is not simply related to the Darcy's Law or to the Bernoulli's theorem. The potential gradient is heterogeneous, and is determined by the transmissibility-structure within the construction and by the pump pressure. Relevant to the system is a third law in hydrodynamics regulating fluid flow: the law of continuity. When water is pumped continuously out of hydrotransistor, the rate through the fine filter must be the same as that through the protective mantle and that through the pipe. This is achieved through an adjustment of the field potentials of the hydrodynamic system of a hydrotransistor. This Hsu Principle of adjusting the hydrodynamic potentials in a hydrodynamic field to achieve flow continuity is the essence of the invention of F-hydrotransistors.

R-, IR and RF-Hydrotransistors

A conventional practice in groundwater recharge is to dig a gravel pit to be filled by rain- or flood-recharge. The simplest model of R-hydrotransistor for groundwater recharge is a shallowly buried gravel pit (FIG. 3). Water is filtered by a F-hydrotransistor (50) before it enters the gravel (52). The accelerate the lateral flow, potential gradient can be established, water is pumped in at one side of the pit (54) and out at the other (56) through perforated pipes (58). Water leaks slowly down through the vadose zone to recharge the groundwater.

We invented the R-hydrotransistors to minimize the evaporation loss during recharge and to retain the use of surface land. We soon discovered, however, that a fraction of water being recharge in the R-hydrotransistor is drawn up, when the recharger is nearly full, into the pores of and wet the soil (60). Lawns, golf courses, meadows, and crop fields above such R-hydrotransistors need no watering.

We designed an IR-hydrotransistor for the dual purpose of groundwater recharge and irrigation (FIG. 4). A layer of sand (62) is buried at about 1 m. depth. Water to be recharge enters a gravel-filled (64) trough between crop fields. A lateral hydrodynamic gradient across the sand layer through the installation of two potentials, a positive potential to pump water into the sand, and a negative potential to pump water out of the sand. The thickness of the sand layer is determined by the rate of recharge: there should be enough water in the interstices of the sand layer, so that water could be drawn up by capillary action to wet the soil. Our experiences at Minqin suggested that the layer could be about 30 cm thick. There will be capillary action to wet the soil even if water is introduced weekly.

To minimize the water-loss from the recharger, another sand layer (66) is buried at a shallow depth, e.g., 30 cm. This upper sand layer is filled with water at the time when the crops are seedlings. Water drawn up into the capillary of the upper soil could nourish the seedlings. We learned from our experiments in Kansu that the seedlings grow and have roots, within a few weeks, deep enough to penetrate through this upper sand layer. At that time, the water-head of the trough (70) can be adjusted to fall between levels of the upper and lower sand layers. Water to be recharged can then enter only the lower sand layer (62). Water is then only drawn up into the sandy soil (72) to nourish the growing crops. The upper sand becomes a hydro-insulator, because the large pores of the sand cut off the capillary pressure so that no water can be drawn up above the upper sand. We have noted that the crops in Kansu in the last two months requires little water for their growth, because evaporative loss from the soil is almost nil then.

At Minqin Kansu, we constructed an I-hydrotransistor with perfectly sealed bottom, and a “bottomless” RI hydrotransistor. From the results we calculated that we needed 0.27 m³/m² water or 270 mm to irrigate the corn, while 1250 mm has been recharged to the groundwater reservoir. This represents a rise of the groundwater table under the irrigating crop field of 1.25 m!

Where circulating groundwater is used for irrigation, the IHC—irrigation method would still result in a deficit of 0.12 m³/m² or 120 mm. This deficit can be compensated by rain- and flood recharge, even where the annual rainfall is only 200-300 mm. In an on-going experiment in Kansu, China, we build FR-hydrotransistors (68) at the mouth of gullies coming out of the hills to filter the flood water, first filtered and stored in an underground gravel pits. The filtered water is then pumped into the IR-hydrotransistors. The rainy season for recharging comes late in Kansu. Groundwater has to be pumped up for irrigation during much of the growing season. The irrigation loss of circulating groundwater in the Spring and Summer should be replaced by the recharging in Autumn and Winter. Through an adjustment of the ratio of the collecting and the recharging areas, a balanced or a surplus of water budget can be achieved.

The greatest application of a combination of FR and IR hydrotransistors in an IHC is land reclamation. The cost of reclamation is mainly labor cost. If the Government establishes a national program to compensate the labors of land reclamation by long-term lease of the reclaimed land, the greening of deserts could be economically feasible.

The IR-hydrotransistors are also very suitable to irrigate lawns of city parks, of large palaces, of golf courses etc.: a sand layer can be buried at a depth of about 30 cm. Rooftop rain-harvests could be used as a source for recharge, and lateral gradients could be established to accelerate its lateral movement. The installation of such devices could replace sprinkling system, save water for irrigation, but also the labour of watering.

IF- and IFR-Hydrotransistors.

IF-Hydrotransistors to combine simultaneously the functions of filtering and irrigation. A small 3×8×0.5 m³ IF-hydrotransistor on the side of a swimming pool serves the function of filtering the pool water and irrigating the lawn above, Where meteoric water has to be recharged underground, as is regulated by numerous European cities, a bottomless construction can be designed to serve as an IFR-hydrotransistor.

FE-Hydrotransistors

Hydroelectricity generation requires the rapid descent of a very large volume of water so that dams are built to store surface water in reservoirs. The problem of using groundwater to generate electricity requires a) rapid collection of water, b) effective filtering, and c) rapid floodwater recharge.

At Dongguang, China, where we need to build F-hydrotransistors to filter the water from a reservoir behind a dam, we build Type D F-hydrotransistor that serves the dual purpose of filtering and of quick discharge. Type D has a sand filter above the layer of gravel embedding perforated pipes, as well as a sand filter beneath. Water coming into the pipes from both above and below is pumped at twice as high a rate as normal Type A F-hydrotransistors. While water pumped into the filtering pool going through the overlying sand filter has suspended particles, and thus requiring frequent retrofluxing, the water from the lake recharging into the groundwater reservoir and coming into the Type D from below should be free of suspensions, so that the underlying filter needs no retro-flushing.

Another method to obtain quick discharge from interstitial water in porous sediments is to drill numerous horizontal water-wells. With the construction of such an IHC system, enough water could be collected from sediments of alluvium, of silted reservoirs, or from muddy rivers, to flow through tunnels on the side of steep gorges into electricity plants to generate hydroelectricity.

The electricity generation at the San Men Gorge Electricity Work is reduced almost to nil, because the reservoir behind the high dam is silted up. Instead of busting the dam with all the attendant costs and environmental problems, we are investigating, in cooperation with the Chinese Ministry of Water Affairs, the feasibility of installing an IHC to extract water from the silty sediments or filter water from the sediment-laden Yellow River to rejuvenate the San-Men Gorge Electricity Work.

### BRIEF DESCRIPTIONS OF DRAWINGS

FIG. 1. No Water Shortage:

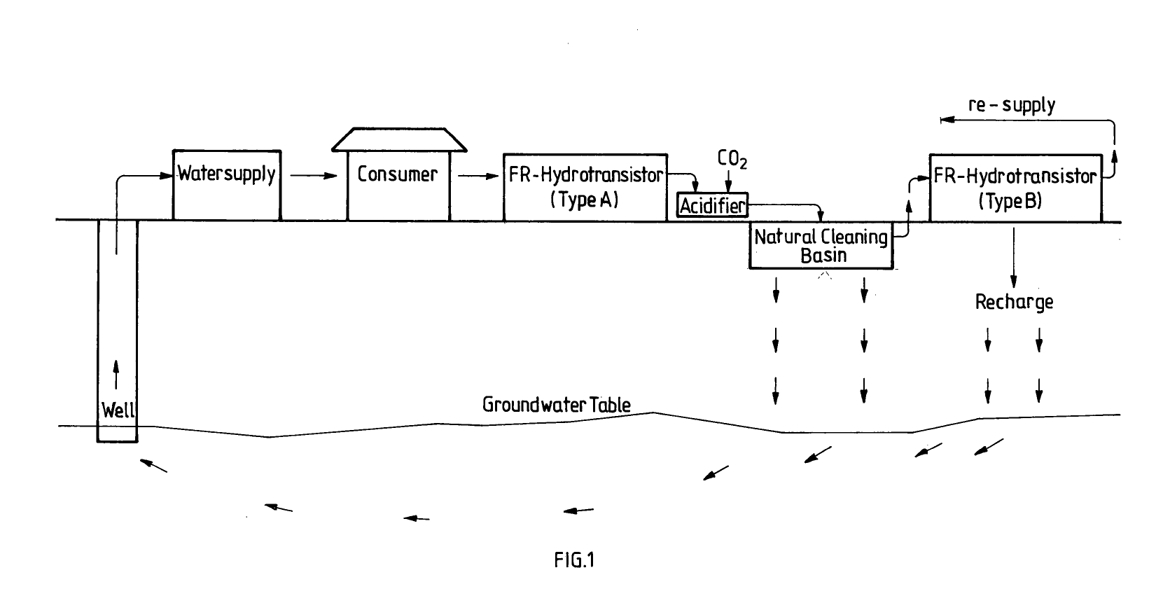

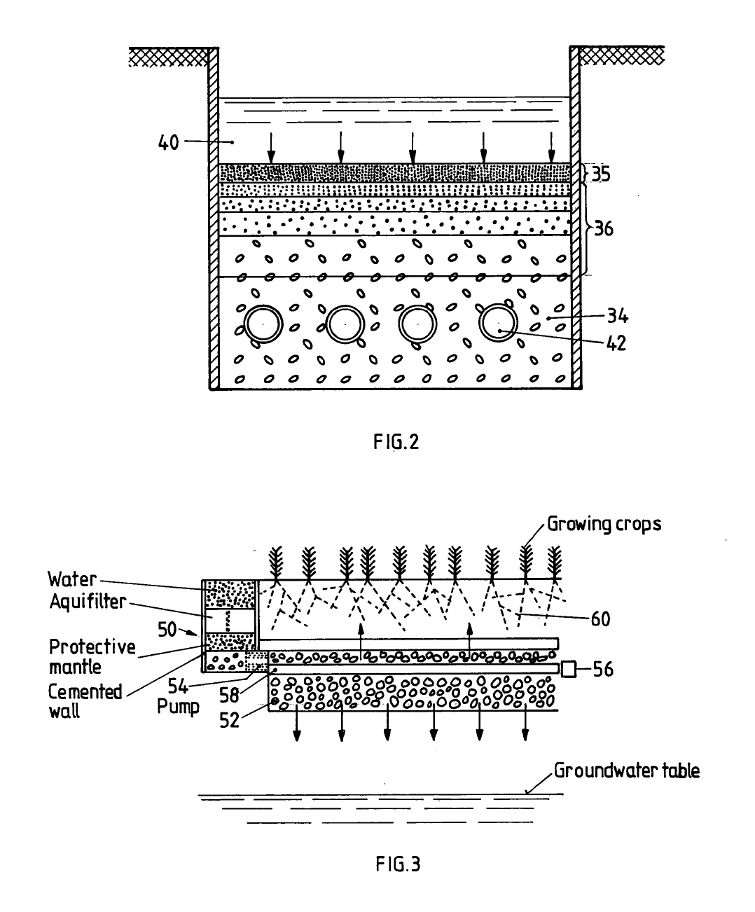

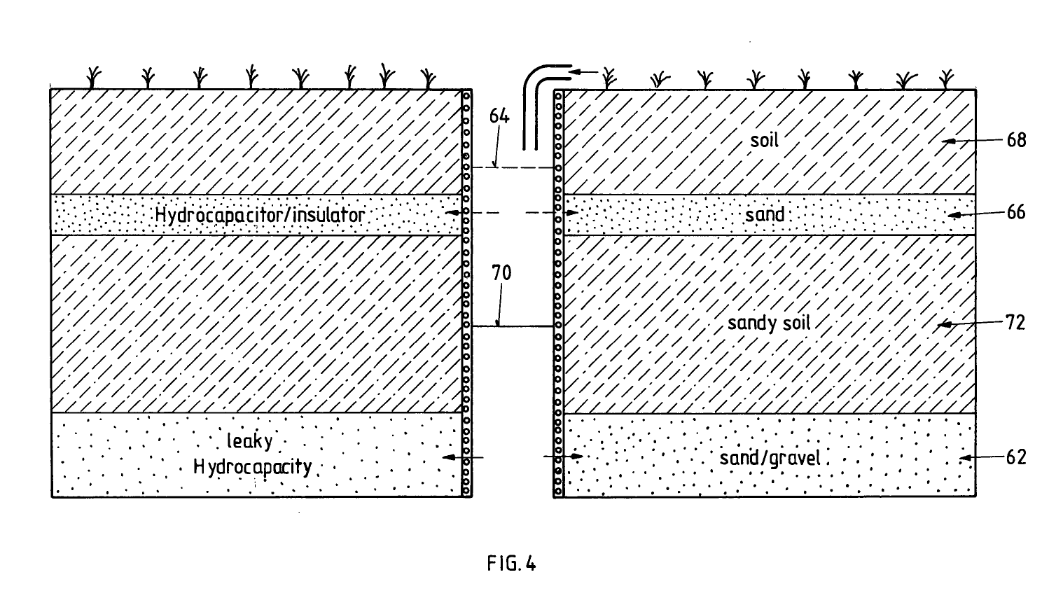

The figure illustrates the application of the IHC technology urban water recycling. Water resources of the City are either filtered from a surface reservoir or pumped up from the groundwater reservoir. Sewage collected by a sewage-net is emptied in canals which are built to protect surface water-resources from pollution. The polluted canal water is pumped into F-Hydrotransistor Type A, where it is filtered to have a quality equal to or better than that of normal tape water. The filtered water is acidized to pH=6-7 in order to prevent the growth of polluting algae (green and blue green algae). The lake water leaks underground to recharge groundwater, or the scenic water is pumped again into F-Hydrotransistor Type B, where it has a quality equal to that bottled “drinking water” sold in supermarket: this type of filtered water, devoid of intestine bacteria and with a better far quality than that of tape water will be called Jing Water, when it is certified to be marketable as bottled healthy drinking water. The Jing Water can be distributed as urban water supply, before it is again used to become sewage, thus the cycle is completed. Where the surface reservoir is insufficient for water-supply, exploitation of groundwater under regulated circumstances is permitted. The quantity of groundwater exploited has to be less than that from rain- and flood-recharge by the IR-Hydrotransistors. The urban water budget is thus balanced.

FIG. 2. F-Hydrotransistor

F-hydrotransistors consists of three components: i) a filtering layer of sediment grains (35), ii) a layer of sand or gravel (34) with embedded in perforated pipes, and iii) a protective mantle (36) between the filter and the gravel layer. The grading of the sedimentary material in the mantle from fine to coarse sand will prevent sedimentary grains from an upper layer from falling into the pores of the underlying layer. Water is pumped into a filtering pool (40), passing through, under a negative potential gradient, the filter, protective mantle, and is pumped out of the perforated pipes (42).

FIG. 3. R-Hydrotransistor

A conventional practice in groundwater recharge is to dig a gravel pit to be filled by rain- or flood-recharge. The simplest model of R-hydrotransistor for groundwater recharge is a shallowly buried gravel pit. Water is filtered by a F-hydrotransistor (50) before it enters the gravel (52). The accelerate the lateral flow, potential gradient can be established, water is pumped in at one side of the pit (54) and out at the other (56) through perforated pipes (58). Water leaks slowly down through the vadose zone to recharge the groundwater. A fraction of water being recharge in the R-hydrotransistor is drawn up, when the recharger is nearly full, into the pores of and wet the soil to nourish the roots of plants (60).

FIG. 4. IR Hydrotransistor

An IR-hydrotransistor for the dual purpose of groundwater recharge and irrigation. A layer of sand (62) is buried at about 1 m. depth. Water to be recharge enters a gravel-filled (64) trough between crop fields. A lateral hydrodynamic gradient across the sand layer can be established through the installation of two potentials, a positive potential to pump water into the sand, and a negative potential to pump water out of the sand. The thickness of the sand layer is determined by the rate of recharge: there should be enough water in the interstices of the sand layer, so that water could be drawn up by capillary action to wet the soil. Our experiences at Minqin suggested that the layer could be about 30 cm thick. There will be capillary action to wet the soil even if water is introduced weekly.

To minimize the water-loss from the recharger, another sand layer (66) is buried at a shallow depth, e.g., 30 cm. This upper sand layer is filled with water at the time when the crops are seedlings. Water drawn up into the capillary of the upper soil could nourish the seedlings. We learned from our experiments in Kansu that the seedlings grow and have roots, within a few weeks, deep enough to penetrate through this upper sand layer. At that time, the water-head of the trough (70) can be adjusted to fall between levels of the upper and lower sand layers. Water to be recharged can then enter only the lower sand layer (62). Water is then only drawn up into the sandy soil (72) to nourish the growing crops. The upper sand becomes a hydro-insulator, because the large pores of the sand cut off the capillary pressure so that no water can be drawn up above the upper sand. We have noted that the crops in Kansu in the last two months requires little water for their growth, because evaporative loss from the soil is almost nil then.

### Publications by Inventor

U.S. Pat. No. 6,120,210, Sep. 19, 2000 Use of Porous Medium in an Integrated Hydrologic Circuit for Water Storage and Transport in land Reclamation, Agriculture, and Urban Consumption
Taiwan Patent 477852, March 2002 Integrate Hydrologic Circuit.
Taiwan Patent 89114962 April 2002. Integrated Hydrologic Circuits in Valley-systems, for Water-supply, Hydroelectricity and Flood Control
European Patent Application PCT Nr. 03 739 927.6, Jul. 1, 2003, national phase in Japan filed January 2006. A Process for the suppression of the growth of algae.
European Patent Application PCT Nr. 03 739 927.6, Jul. 1, 2003, national phase in USA filed January 2006. A Process for the suppression of the growth of algae.
European Patent Application PCT Nr. 03 739 927.6, Jul. 1, 2003, national phase in Canada, filed January 2006. A Process for the suppression of the growth of algae.
Switzerland PCT/CH 2004/000372, June 2004. Aquitransistors in Integrated Hydrologic Circuits.
Switzerland PCT/CH 2004/000372, June 2004, national phase in USA filed November 2006.
Switzerland PCT/CH 2004/000372, June 2004, national phase in UK filed November 2006.
Switzerland PCT/CH 2004/000372, June 2004, national phase in India filed November 2006.
Chinese Application for Invention No. 03123273, filed November 2004. Aquitransistors for integrated hydrologic circuit.
Chinese Application for Invention No. 03826672, filed January 2006. A Process for the suppression of the growth of algae.
Switzerland PCT/CH 2006/000002, January 2006. Process for combating water polluted by algae.

1-10. (canceled)

11. A filtering hydrotransistor arrangement for filtering polluted water and waste-water, comprising
an upper filtering layer of sediment grains,
perforated pipes embedded in a layer of sand or gravel, and
a protective mantel layer present between the filtering layer and the layer of sand or gravel with a grading of sedimentary material including fine to coarse sand.

12. The arrangement according to claim 11, wherein the sediment grains of the upper filtering layer has a pore size reduced down to at least 1-2 micrometers.

13. The arrangement according to claim 11, wherein the grading of sedimentary material in the mantel layer prevents sedimentary grains within the upper filtering layer from falling into the layer of sand or gravel which is porous and in which the perforated pipes are embedded.

14. The arrangement according to claim 12, wherein the grading of sedimentary material in the mantel layer prevents sedimentary grains within the upper filtering layer from falling into the layer of sand or gravel which is porous and in which the perforated pipes are embedded.

15. The arrangement according to claim 11 or 12, further comprising a suction pump to pump water out of the perforated pipes.

16. The arrangement according to claim 11 or 12, wherein the upper filtering layer includes sorted fine grained sand as a filter.

17. The arrangement according to claim 11 or 12, wherein the upper filtering layer includes medium silt or a diatomaceous earth as a filter.

18. The arrangement according to claim 11 or 12, wherein the upper filtering layer includes a sand or silt filter mixed with chemicals which precipitate toxic ions in polluted water.

19. The arrangement according to claim 11 or 12, wherein above the upper filtering layer is arranged a filtering pool in which polluted water and waste-water is pumped and which passes through into the upper filtering layer and the layer of sand or gravel and the mantel layer under a negative potential gradient which is established in the arrangement by pumping water out of the pipes.

20. A process for filtering polluted water and waste-water in an arrangement of filtering layers comprising filtering the water in a layer of sediment grains, the water flowing under gravity through a fine or medium sand filter into a semi-conducting medium of coarse sand or gravel, from where the water enters perforated pipe.

21. The process according to claim 20, wherein flow rate of the water is a function of power of a pump to create a pressure difference across a length of the perforated pipe to increase a negative potential gradient which is established within the arrangement of filtering layers.
